(19) United States
(12) Patent Application Publication
(10) Pub. No.: US 2021/0201419 A1
(43) Pub. Date: Jul. 1, 2021

(54) Method for Subsidizing At-Risk Insurance Policyholders

(71) Applicant: Karl Miller, Coral Springs, FL (US)

(72) Inventor: Karl Miller, Coral Springs, FL (US)

(21) Appl. No.: 16/732,314

(22) Filed: Jan. 1, 2020

(51) Int. Cl. G06Q 40/08; G06Q 20/10; G06Q 40/00

(52) U.S. Cl. CPC G06Q 40/08; G06Q 40/10; G06Q 20/108

(57) ABSTRACT

This invention relates in general to a system and a method which links charitable donations with the subsidizing of insurance policies. The system and process manage donations in such a way as to keep delinquent policyholders from losing coverage while also allowing the insurance company to maintain an uninterrupted flow of income and avoid policy lapses.

### FIELD OF THE INVENTION

The present invention is directed to a system and method for managing insurance, particularly microinsurance, and more particularly, to a system and method for managing microinsurance subsidies made via charitable donations.

### BACKGROUND OF THE INVENTION

Microinsurance is a field of insurance coverage in which low income individuals, chiefly in the developing world, are protected against the financial impact of certain perils at levels commensurate with their economic situation. As in more developed nations, insurance can step in to preserve economic progress and protect recipients from falling into deeper levels of poverty in the event of a financial setback. The insurance can be in various types—life, health and crop microinsurance being among the most common. In the typical arrangement, premiums are paid by policyholders directly to the microinsurer or through an arrangement with a cooperative to which the policyholder belongs. Note that any reference made herein to microinsurance specifically applies to insurance generally as well, and the terms insurance and microinsurance are used interchangeably throughout the invention.

Most microinsurance policies are funded by payments from policyholders, either made directly to the microinsurer or through payments made on their behalf by an organization to which the policyholder belongs, such as a cooperative. Under a typical microinsurance arrangement, the policyholder will make an initial payment at the start of the policy period, with additional payments following at regular intervals during the term of the policy. If an event occurs that triggers coverage, the insurer makes a claim payment to the policyholder.

A major drawback with the current microinsurance system is the high rate of policy lapses, or the cancellation of coverage due to the failure of the policyholder to continue making required premium payments. This is attributable to several reasons, including loss of employment, housing instability, and a lack of appreciation for the value of insurance. The failure to make payments results in the policyholder forfeiting coverage and the insurer losing further premium income. It also creates underwriting challenges since expected income streams fail to occur, causing increased uncertainty in financial planning and decreased organizational profitability.

As a result, microinsurance has had great difficulty fulfilling its initial promise of creating a safety net under lower-income residents of developing countries. Rather than writing policies for the full range of products to all that could possibly benefit from them, microinsurers have instead tapped into a small percentage of their potential market. The subsidization of microinsurance can help as an interim step to fix this problem.

The normal arrangement of insurance is illustrated in FIG. 1. As can be seen in FIG. 1, the applicant 1 prepares an application 2 which is received by the insurer 3. An insurance company underwriter 4 evaluates the particular risk posed by that applicant. The underwriter then decides 5 to decline the risk 6 or to accept it 7. If the applicant is accepted, the insurer sends policy documents 8, including an invoice for the initial premium payment, to the applicant, now the insured. The insured then makes the initial premium payment 9 which is received by the insurer 10 and applied to pay for coverage.

The insurer's billing department 11 will monitor if a policyholder is late in making a scheduled premium payment. If the premium payment has been made timely 12, the policy continues in effect without interruption 7. Once a payment is overdue, however, typically a grace period 13 is specified, so that the policy remains effective and will continue to pay benefits, even though the required payment has not been received. If the grace period is exceeded, the policy is deemed to have lapsed—coverage is terminated 14 and a cancellation notice 15 is sent to the policyholder informing them accordingly 16.

A number of problems exist with the current structure of microinsurance, chief of which is an extremely high rate of policy abandonment. In order to plan for the long term solvency of their operations, insurers make financial projections regarding expected premium receipts as well as claim outlays and other costs. These projections become less accurate when policies have an excessively high lapse rate, throwing off the overall financial planning of the insurer and potentially causing financial danger to the company.

Due to the uncertainty involved in writing microinsurance, institutions have arisen to try to stabilize microinsurance by giving direct financial assistance to insurance companies. This is essentially a supply-side support in which grants are provided to the insurer in order to help keep income even and to protect the organization's financial health.

A major problem with this type of supply-side support is that it does little to solve the underlying issue of excessive policy abandonment since it does not directly help the policyholder who is experiencing difficulties in making premium payments. Even the lower-priced policies that are subsequently possible with supply-side support can still be difficult purchases for lower-income policyholders with unstable income.

### SUMMARY OF THE INVENTION

The present invention helps solve the problem of high insurance lapse rates by applying charitable donations in a unique manner that not only stabilizes the underwriting process of the insurer, but also keeps coverage in place for the policyholder.

The present invention handles such donations to insurance companies in a way that allows benefit to go to both the insurance company and the policyholder. The invention treats the donation in such a manner that the insurer continues to receive the premium it was expecting when the policy was underwritten, while the policyholder simultaneously continues to receive the protection of the policy. This results in a more efficient and equitable system for continuing coverage, utilizing prior underwriting analysis and keeping expected premium flowing to the insurer.

Insurers utilizing the present invention underwrite policies in various lines of coverage—life, health, weather, etc. It is noted that the invention may provide for continued coverage to policyholders using any of those types of insurance, for just a single policyholder or as many as several hundred.

In a variation of this invention, coverage subsidies may also be applied through a cooperative that deals with insurers on behalf of its members. In this instance, premiums are collected by the cooperative and forwarded to the insurer to activate coverage for paying members. Donations may then be used to help subsidize members who are delinquent in scheduled premium payments. Similarly, a charitable organization can arrange subsidies on behalf of its clients.

### BRIEF DESCRIPTION OF THE DRAWINGS

FIG. 1 is a flow chart depicting the arrangement of a typical insurance plan.

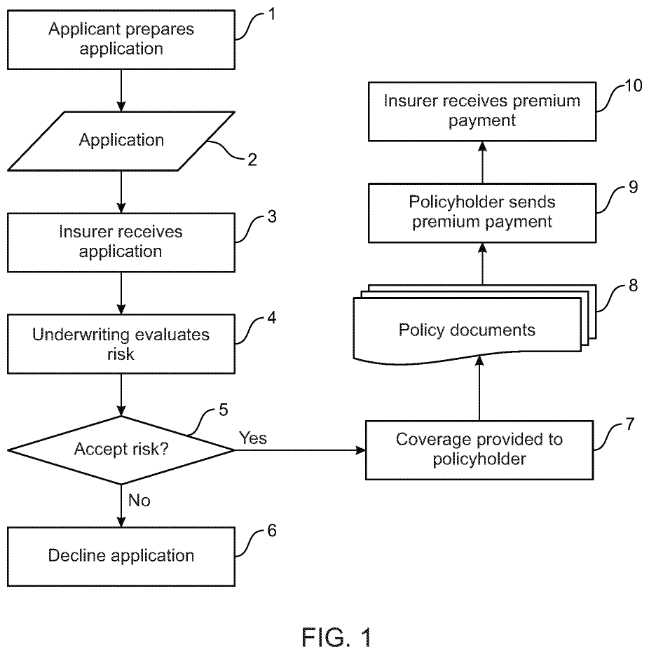

FIG. 2 is a flow chart showing the cancellation process of a typical insurance policy.

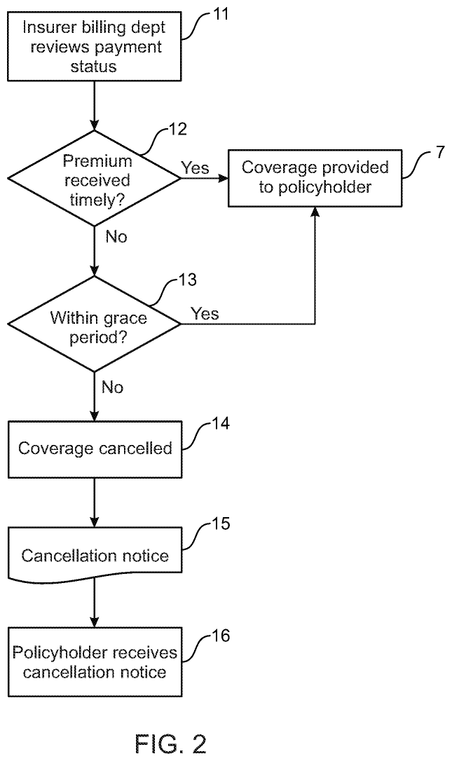

FIG. 3 is a flow chart showing the microinsurance subsidy plan according to a preferred embodiment of the present invention.

FIG. 4 illustrates the subprocess by which the recipient of the insurance donation is arbitrarily selected.

### DESCRIPTION OF THE PREFERRED EMBODIMENT

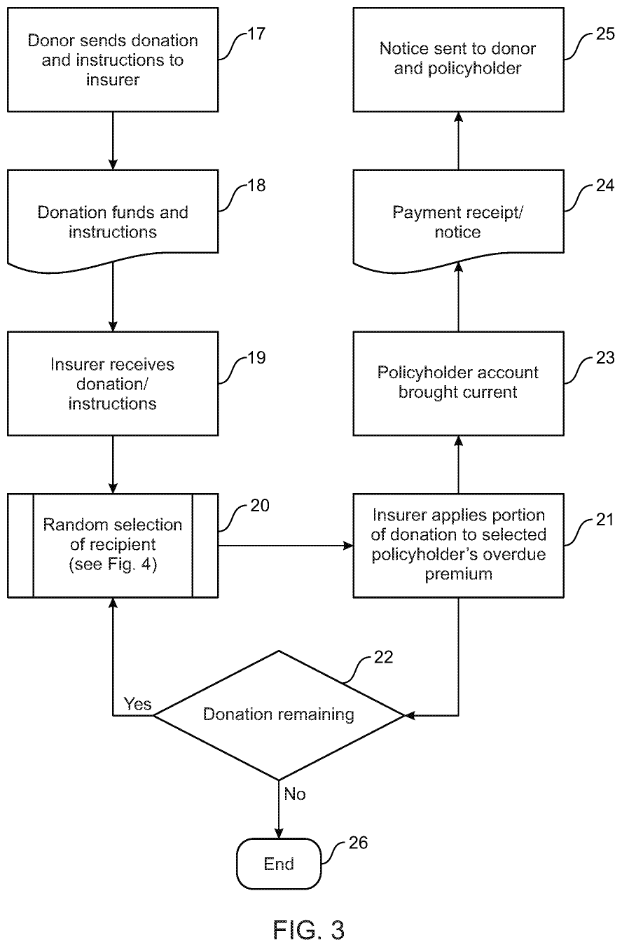

FIG. 3 generally depicts the insurance donation flow according to a preferred embodiment of the system and method of the present invention. Throughout the figures shown, consistent numerals are utilized to reference elements in each. In addition, reference is typically to an individual policyholder.

FIG. 3 shows the invention by which a donor pays funds 17 directly to the insurer to help delinquent policyholders who are in the grace period. Funds may be sent to the insurer by any suitable means, depending upon the ability of the insurer to accept and process funds in each such manner.

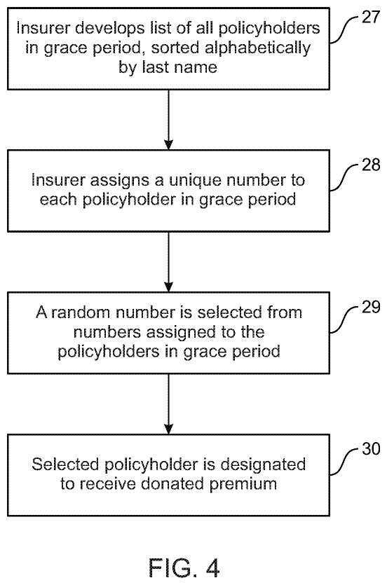

The donor instructs the insurer to apply the donation toward randomly selected policyholders who are still within the grace period before cancellation. The recipient's coverage is then renewed and brought up-to-date. This explanatory instruction 18 from the donor may be sent as a field in the payment document or via a separate correspondence sent concurrently with the payment. Once the insurer receives payment and instructions 19, it randomly selects 20 a recipient from the pool of delinquent policyholders still in the grace period through a subprocess described in FIG. 4.

Once the insurer has selected a recipient, the donated funds are applied to pay the delinquent premium amount 21 thus bringing the account into compliance so that coverage remains effective 23. A payment notice or receipt 24 is then generated and sent to the insured and the donor as documentation of the transaction 25. If funds remain 22 from the donation, additional payments are generated for other such randomly selected recipients until the donation is exhausted 26. In the event the remaining donation amount is insufficient to pay the entirety of a recipient's overdue balance, it will be applied to reduce the balance accordingly.

FIG. 4 illustrates the subprocess by which the insurer selects recipients for the donation. First, the insurer develops a list of all policyholders that are currently overdue on premium payments but are still within the grace period. The insurer then sorts the list alphabetically by last name 27. A number is given to each listed policyholder until all policyholders in the grace period have a unique assigned number 28. From this set of numbers, a single number is randomly selected 29. The policyholder corresponding to the selected number is then designated 30 to receive payment from the donated funds. The overdue balance of the selected policyholder is then paid using funds from the donation 18.

Funds may be donated by various means, as long as they are acceptable to an insurer who has previously agreed to process donated funds in the manner described in this invention. If the insurer is set up to receive funds electronically, the money can be sent directly through a credit card. However, an alternate electronic system of payment such as PayPal can be used as well. If the insurer is not equipped to accept funds electronically, international money orders or personal checks may potentially be used.

In order to accomplish the selection outlined in steps 28 and 29, any random number generating software such as Microsoft RAND or CryptGen Random can be utilized in conjunction with a Microsoft Excel spreadsheet application or whichever means has been selected to organize the names of potential recipients. These can be used to organize the names of policyholders and assign a distinct number to each in the grace period then choose a single recipient from the pool of numbers.

The method of communicating the instruction for the donation to be used to pay for policyholders who are overdue in payments but still in the grace period can be done in a way congruent with the method of payment. If a donation is made electronically, an email can be sent to the insurer simultaneously to give payment instructions. If the donation is made by traditional mail, then a letter accompanying the payment can direct the usage of the donation. In the ideal embodiment of this invention, the insurer would have a designated area on its website specifically for donations to help delinquent policyholders.

When the donation is received, the insurer should review its records at that point in time to determine which policyholders are overdue in paying premium but not yet at the point of cancellation. This set of policyholders in the grace period is typically a well-established function of an insurer's billing department and should be readily ascertainable.

Once the donation has been applied to an overdue account, the insurer should communicate payment to the policyholder by whatever means it normally would use to acknowledge a premium payment actually made by the policyholder. This can be accomplished by a variety of methods⇒by physical delivery of a paid receipt for the overdue premium, by email, or by traditional mail.

If an overlap occurs in which a payment from a delinquent policyholder is received after application of donated funds has already been applied to that policyholder's account, the newly-received payment can be applied to a subsequent premium installment or refunded back to the policyholder.

Concurrent with the notice to the policyholders who received benefit from a donation, communication should be sent to the donor specifying the amounts given to each recipient. As with notice to the policyholder, this can be done by whatever means are normally used by the insurer—either via electronic communication or by traditional mail.

As this invention is intended to be an interim measure to help policyholders in need, it is expected that the policyholders themselves will make subsequent premium payments to keep policies in effect going forward.

As payments from a particular donation are applied to a policyholder's account, the insurer's records will be updated accordingly to show receipt of the overdue premium. The status of the account in question will then be updated to show that the policyholder is current on premium payments.

By using a random selection of delinquent policyholders, the present invention avoids the potential moral hazard by which some policyholders would deliberately not make payments in reliance on donors making them instead. By applying donations to random delinquent policyholders, there would be no expectation that intentionally missing a premium payment would not result in cancellation of the policy and a consequent loss of coverage.

With respect to concerns that an insurer would not use donated funds as intended, note that insurers are typically regulated much more stringently than a charitable organization. There is consequently less likelihood an insurer would misuse funds than an ordinary charity might. Insurers would establish in advance that they are willing to accept donations so that the precedent for receiving funds would already be recognized and a procedure for handling donations previously put in place.

There is a remote but unlikely possibility that an insured has purchased a microinsurance policy such as for life or health coverage but no longer is in need of it a short time after making the initial purchase. In that case, the policyholder can inform the insurer directly that they do not wish the donated funds to apply to their account, and the insurer can accordingly rescind the payment from the original designated account then apply it to a different randomly-generated policyholder.

Any appropriate hardware capable of operating the preceding programs may be used. In almost all instances, the hardware currently used by the insurer would be sufficient to administer the system of insurance donation described in the present invention.

The preceding is for illustrative purposes only. Within the scope of the invention, modifications are possible as defined by the appended claims.

What is claimed is:

1. A method of providing financial support to an insurance program using a computerized system to randomly apply donations to recipients so that both the insurer and the policyholder receive benefit, said method comprising the steps of:
receiving funds from donors wishing to support insurance efforts especially in the developing world;
using a computerized system to develop a pool of potential recipients from those policyholders delinquent in making premium payments but not yet at the point of cancellation;
randomly selecting recipients from said pool;
applying donated funds to bring such selected delinquent policyholders up-to-date on premium payments; and
using this system to obtain greater underwriting consistency and insurer stability while simultaneously aiding policyholders in financial difficulty.

2. A method as in claim 1, further comprising the step of continuing insurance in place for delinquent policyholders who remain in a grace period.

3. A method as in claim 1, further comprising the step of continuing income flow for an insurer.

4. A method as in claim 1, wherein a policyholder's coverage may continue even if they miss a scheduled premium payment.

5. A method as in claim 1, wherein a subsystem is utilized to randomly determine recipients from among delinquent policyholders in a grace period.

6. A method as in claim 1, in which insurer records are updated and both the recipient and donor are notified of the manner in which the donated funds have been applied.
